(19) United States
(12) Patent Application Publication
(10) Pub. No.: US 2011/0161678 A1
(43) Pub. Date: Jun. 30, 2011

(54) CONTROLLER FOR CONTROLLING NAND FLASH MEMORY AND DATA STORAGE SYSTEM

(76) Inventor: Yasuyuki NIWA, Chiba-shi (JP)

(21) Appl. No.: 12/844,308

(22) Filed: Jul. 27, 2010

(30) Foreign Application Priority Data
Dec. 24, 2009 (JP) 2009-293270

(51) Int. Cl. G06F 12/14

(52) U.S. Cl. 713/193; 711/E12.001; 711/E12.008; 711/E12.092; 711/103

(57) ABSTRACT

According to one embodiment, a controller controlling a storage device connected to a host device and storing data includes a pseudorandom number generator, and a scramble circuit. The pseudorandom number generator generates a pseudorandom number based on identification information of the controller. The scramble circuit scrambles data received from the host device using the pseudorandom number.

### CROSS-REFERENCE TO RELATED APPLICATIONS

This application is based upon and claims the benefit of priority from Japanese Patent Application No. 2009-293270, filed Dec. 24, 2009; the entire contents of which are incorporated herein by reference.

### FIELD

Embodiments described herein relate generally to a controller for controlling a NAND flash memory and a hard disk device, and a data storage system, for example.

### BACKGROUND

Recently, a method of preventing information leakage is taken by encoding data and writing the same to a storage medium in a cell phone, a personal computer and the like. An example of encoding includes a method of using a pseudorandom number. The pseudorandom number is generated based on a certain initial value (hereinafter, referred to as a seed value). Jpn. Pat. Appln. KOKAI Publication No. 2009-157836 discloses encoding the data using the pseudorandom number generated based on the seed value.

However, in the above-described method, the seed values are common in each controller for controlling the storage medium and each version of firmware.

### BRIEF DESCRIPTION OF THE DRAWINGS

FIG. 1 is a block diagram of a memory system according to a first embodiment;

FIG. 2 is a view illustrating signal assignment to a signal pin in a memory card according to the first embodiment;

FIG. 3 is a block diagram of the memory card according to the first embodiment;

FIG. 4 is a circuit diagram of a memory cell array of a NAND flash memory according to the first embodiment;

FIG. 5 is a view illustrating threshold distribution of the NAND flash memory according to the first embodiment;

FIG. 6 is a schematic diagram of a register according to the first embodiment;

FIG. 7 is a wafer map according to the first embodiment;

FIG. 8 is a block diagram of an encoder/decoder according to the first embodiment;

FIG. 9 is a schematic diagram of a scramble table according to the first embodiment; and

FIG. 10 is a schematic diagram of a hard disk device according to a second embodiment.

### DETAILED DESCRIPTION

Hereinafter, a first embodiment will be described with reference to the drawings. In this description, a common reference numeral is assigned to a common part throughout the drawings.

In general, according to one embodiment, a controller controlling a storage device connected to a host device and storing data includes a pseudorandom number generator, and a scramble circuit. The pseudorandom number generator generates a pseudorandom number based on identification information of the controller. The scramble circuit scrambles data received from the host device using the pseudorandom number.

### First Embodiment

### Entire Configuration of Memory System

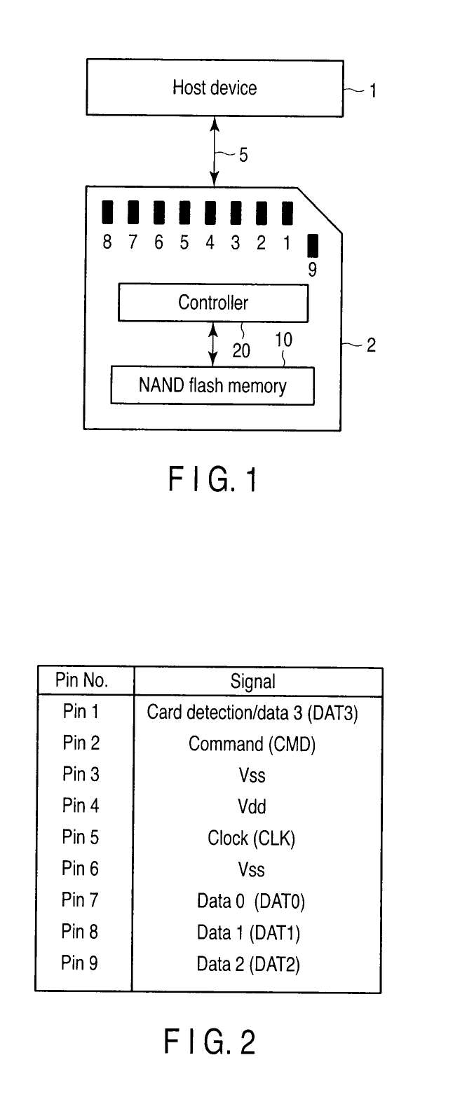

A controller and a data storage system according to the first embodiment will be described with reference to FIG. 1. FIG. 1 is a block diagram of the controller and the data storage system according to this embodiment. The block diagram illustrates a configuration in which an SD™ memory card (hereinafter, simply referred to as a memory card 2) is used as an example of the data storage system.

The memory card 2 comprises a NAND flash memory 10 and a controller 20 which controls the NAND flash memory. The memory card 2 may be connected to a host device 1. The memory card 2 writes the data from the host device 1 to the NAND flash memory and erases the same, and reads the data from the NAND flash memory to the host device 1.

The host device 1 is connected to the memory card 2 through a host bus interface (hereinafter, sometimes simply referred to as a host bus) 5. The host device 1 comprises hardware and software to access the memory card 2.

The memory card 2 includes the NAND flash memory and the controller which controls the NAND flash memory. Also, the memory card 2 is supplied with power to operate when connected to the host device 1. The memory card 2 performs a process according to access from the host device 1. The memory card 2 includes the NAND flash memory, for example. The memory card 2 saves the data in the NAND flash memory according to request of the host device 1, and reads the saved data from the NAND flash memory to output the same to the host device 1. Hereinafter, a detailed configuration of the memory card 2 will be described.

### Configuration of Memory Card 2

As illustrated in FIG. 1, the memory card 2 communicates information with the host device 1 through the host bus interface 5. The memory card 2 includes a NAND flash memory chip (sometimes simply referred to as the NAND flash memory or a flash memory) 10, the controller 20 which controls the flash memory chip 10, and a plurality of signal pins (first to ninth pins).

A plurality of signal pins are electrically connected to the controller 20. Assignment of signals to the first to ninth pins is as illustrated in FIG. 2, for example. FIG. 2 is a table illustrating the first to ninth pins and the signals assigned to the first to ninth pins.

The seventh, eighth, ninth and first pins are assigned to data 0 to 3, respectively. The first pin is also assigned to a card detection signal. Further, the second pin is assigned to a command, the third and sixth pins are assigned to ground potential Vss, the fourth pin is assigned to power supply potential Vdd and the fifth pin is assigned to a clock signal.

Also, the memory card 2 is formed to be insertable and removable to and from a slot provided on the host device 1. A host controller (not illustrated) provided on the host device 1 communicates various signals and data with the controller 20 in the memory card 2 through the first to ninth pins. For example, when the data is written to the memory card 2, the host controller transmits a write command as a serial signal to the controller 20 through the second pin. At this time, the controller 20 loads the write command given to the second pin in response to the clock signal supplied to the fifth pin.

Herein, as described above, the write command is serially input to the controller 20 using only the second pin.

As illustrated in FIG. 2, the second pin assigned to an input of the command is arranged between the first pin for the data 3 and the third pin for the ground potential Vss. A plurality of the signal pins and the host bus interface 5 for the same are used for the communication between the host controller in the host device 1 and the memory card 2.

On the other hand, the communication between the flash memory 10 and the controller 20 is performed by a NAND bus interface 21 (hereinafter, sometimes simply referred to as a NAND bus) for the NAND flash memory to be described later. Therefore, although not illustrated, the flash memory 10 and the controller 20 are connected to each other by an 8-bit input/output (I/O) line, for example.

For example, when the controller 20 writes the data to the flash memory 10, the controller 20 sequentially inputs a data input command 80H, a column address, a page address, the data and a program command 10H (or a cache program command 15H) to the flash memory 10 through the I/O line. Herein, “H” of the command 80H indicates hexadecimal notation and an 8-bit signal “10000000” is actually given to the 8-bit I/O line in parallel. That is, a command of a plurality of bits is given in parallel in the NAND bus interface 21.

Also, in the NAND bus interface 21, the command for the flash memory 10 and the data are communicated by sharing the same I/O line. In this manner, the interface (host bus 5) for communication between the host controller in the host device 1 and the memory card 2 is different from the interface (NAND bus 21) for communication between the flash memory 10 and the controller 20.

Next, a detailed configuration of the NAND flash memory 10 and the controller 20 included in the memory card 2 will be described.

### Configuration of NAND flash Memory 10

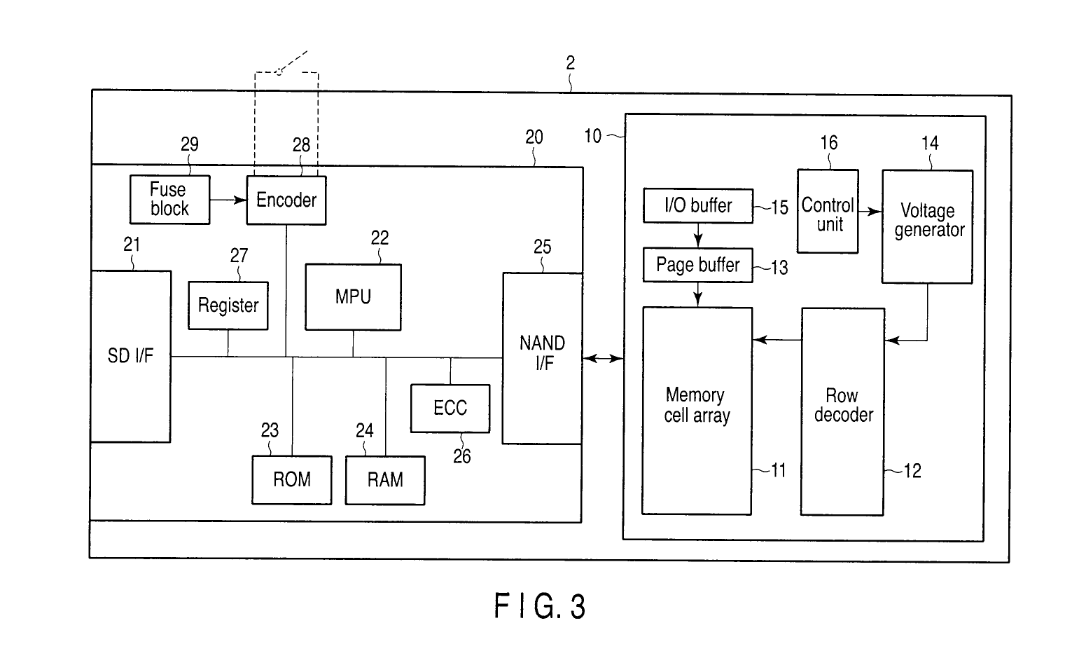

The NAND flash memory 10 will be first described with reference to FIG. 3. FIG. 3 is a block diagram of the NAND flash memory 10.

As illustrated, the NAND flash memory 10 includes a memory cell array 11, a row decoder 12, a page buffer 13, a voltage generator 14, an I/O buffer 15 and a control unit 16. They are integrally formed on the same semiconductor substrate.

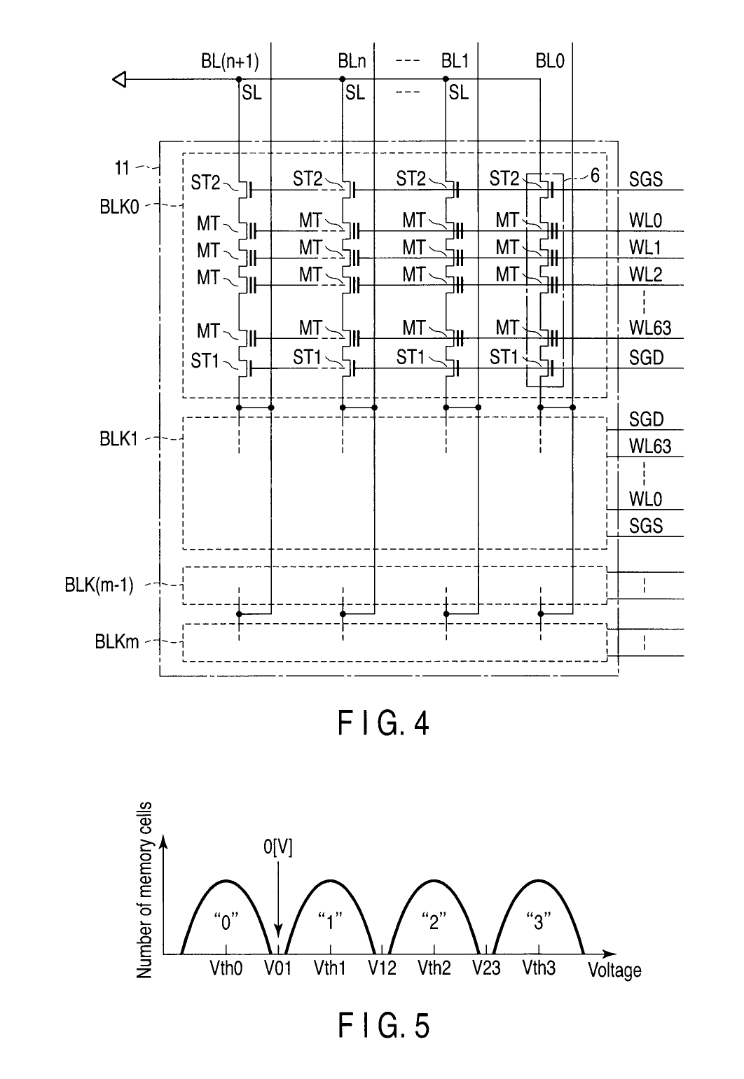

The memory cell array 11 includes a plurality of memory cell transistors and stores the data. A configuration of the memory cell array 11 will be described with reference to FIG. 4. FIG. 4 is a circuit diagram of the memory cell array 11.

As illustrated, the memory cell array 11 includes a plurality of blocks BLK (BLK0 to BLKm) (m is a natural number of 1 or more). Each of the blocks BLK0 to BLKm includes a plurality of NAND strings 6. Each of the NAND strings 6 includes 64 memory cell transistors MT and select transistors ST1 and ST2, for example. The memory cell transistor MT is an n-channel MOS transistor including a stacked gate including a charge accumulating layer (for example, a floating gate) formed on the semiconductor substrate with a gate insulating film interposed therebetween and a control gate formed on the charge accumulating layer with an integrate insulating film interposed therebetween. Meanwhile, the memory cell transistor MT may include a MONOS structure in which the charge accumulating layer is formed of an insulating material. Also, the number of the memory cell transistors MT in the NAND string 6 is not limited to 64, but may be 8, 16, 32, 128, 256 or the like.

In the NAND string 6, adjacent memory cell transistors MT share a source and a drain. They are arranged between select transistors ST1 and ST2 such that current pathways thereof are connected in series. A drain region on one end side of the memory cell transistors MT connected in series is connected to a source region of select transistor ST1 and a source region on the other end side is connected to a drain region of select transistor ST2.

Control gates of the memory cell transistors MT on the same row are connected in common to any one of word lines WL (WL0 to WL63), and gate electrodes of select transistors ST1 and ST2 of the memory cell transistors MT on the same row are connected in common to select gate lines SGD and SGS, respectively. Also, in the memory cell array 11, drains of select transistors ST1 on the same column are connected in common to any one of bit lines BL (BL0 to BLn [n is a natural number of 2 or more]). Sources of select transistors ST2 are connected in common to a source line SL.

The data is collectively written to a plurality of memory cell transistors MT connected to the same word line WL, and this unit is referred to as a page. Further, the data is erased in a block BLK unit.

The above-described memory cell transistor MT has four types of threshold voltages, for example, according to an amount of charge injected into the charge accumulating layer. It is supposed that the memory cell transistor MT may store four types of data by the four types of threshold voltages.

FIG. 5 is a view illustrating threshold distribution of the memory cell transistor MT. As illustrated in FIG. 5, the memory cell transistor MT may hold data “0”, “1”, “2” and “3” in ascending order of the threshold voltages. For example, a threshold voltage Vth0 of the memory cell transistor MT, which holds the “0” data, satisfies Vth0<V01. A threshold voltage Vth1 of the memory cell transistor MT, which holds the “1” data, satisfies V01<Vth1<V12. A threshold voltage Vth2 of the memory cell transistor MT, which holds the “2” data, satisfies V12<Vth2<V23. A threshold voltage Vth3 of the memory cell transistor MT, which holds the “3” data, satisfies V23<Vth3. Also, V01=0V, for example.

The description will be continued with reference to FIG. 3 again. The row decoder 12 selects a row direction of the memory cell array 11 at the time of writing, reading and erasing of the data. The row direction is selected based on a row address given by the controller 20 through the I/O buffer 15.

More specifically, the row decoder 12 selects the word line WL and the select gate lines SGD and SGS. Thereafter, the row decoder 12 transfers an appropriate voltage to a selected word line WL, a non-selected word line WL and select gate lines SGD and SGS.

The page buffer 13 transfers write data to the bit line BL at the time of writing the data. In this manner, the page buffer 13 writes the data to the memory cell transistor MT connected to the selected word line WL. Also, at the time of reading the data, the page buffer 13 senses and amplifies the data read by the bit line BL and outputs a result to the I/O buffer 15.

The voltage generator 14 generates a voltage required for writing, erasing and reading of the data according to control by the control unit 16. The voltage generator 14 supplies the generated voltage to the row decoder 12.

The voltage given by the voltage generator 14 is applied to the selected word line WL, the non-selected word line WL, the select gate lines SGD and SGS and a well region in which the memory cell array 11 is formed by the row decoder 12.

The I/O buffer 15 temporarily holds the write data, the address and the write command supplied from the controller 20 at the time of writing data.

Thereafter, the I/O buffer 15 transfers the address to the row decoder 12. The I/O buffer 15 transfers the address and the write command to the control unit 16. The I/O buffer 15 transfers the write data to the page buffer 13.

Also, at the time of the reading of the data, the I/O buffer 15 receives the address and the read command as at the time of writing. Subsequently, the I/O buffer 15 transfers the address and the read command to the control unit 16. Also, the I/O buffer 15 transfers the address to the row decoder 12.

Also, the I/O buffer 15 outputs the read data received from the page buffer 13 to the controller 20.

Next, the control unit 16 will be described. The control unit 16 controls operation of an entire NAND flash memory 10. That is, the control unit 16 executes a necessary sequence such as writing, reading and erasing of the data based on the above-described address and command given by the controller 20.

### Configuration of Controller 20

Next, the controller 20 will be described with reference to FIG. 3. The controller 20 controls the operation of the NAND flash memory 10 according to an instruction of the host device 1. More specifically, the controller 20 controls writing, reading and erasing of the data for the NAND flash memory 10 and also performs error correction of the read data and parity generation of the write data. Therefore, the controller 20 manages a physical state of the above-described NAND flash memory 10 (for example, what number of logic sector address data is included in which physical block address or which block is in an erased state), for example.

As illustrated in FIG. 3, the controller 20 includes an SD interface 21, a micro processing unit (MPU) 22, a read only memory (ROM) 23, a random access memory (RAM) 24, a NAND interface 25, an ECC circuit 26, a register 27, an encoder 28 and a fuse block 29. They are integrally formed on the same semiconductor substrate. The NAND flash memory 10 and the controller 20 may be formed on the same semiconductor substrate or formed on different semiconductor substrates. In this embodiment, a case in which the both are formed on the different semiconductor substrates will be described as an example.

The SD interface 21 performs an interface process between the controller 20 and the host device 1. The SD interface 21 receives an SD command, the address and the write data, for example, from the host device 1. The SD interface 21 then transfers the received SD command to the MPU 22. Also, the SD interface 21 stores the address and the write data in the RAM 24, for example. Further, the SD interface 21 outputs the data, which should be output to the host device 1, according to an instruction of the MPU 22.

The MPU 22 controls operation of the entire memory card 2. The MPU 22 reads firmware (control program) stored in the ROM 23 on the RAM 24 to execute a predetermined process when the memory card 2 is supplied with the power, for example. In this manner, the MPU 22 creates various tables on the RAM 24.

Also, the MPU 22 receives the write command, the read command and the erase command from the host device 1 and executes a predetermined process to the NAND flash memory 10. Further, the MPU 22 controls the encoder 28 to scramble the write data. The scrambling of the write data will be described later in detail.

The ROM 23 stores the control program and the like controlled by the MPU 22.

The RAM 24 is used as a work area of the MPU 22 and stores the control program and the various tables.

The NAND interface 25 performs the interface process between the memory controller 20 and the NAND flash memory 10. That is, the NAND interface 25 outputs the instruction (write instruction, read instruction, erase instruction and the like) issued by the MPU 22, the address, the write data and the like to the NAND flash memory 10 according to the instruction of the MPU 22. Also, the NAND interface 25 receives the read data supplied by the NAND flash memory 10 to store the data in the RAM 24.

The ECC circuit 26 performs the error correction of the data. More specifically, the ECC circuit 26 detects error of the read page data and performs the error correction when the error is detected. Also, at the time of writing data, the ECC circuit 26 generates the parity required for the error correction.

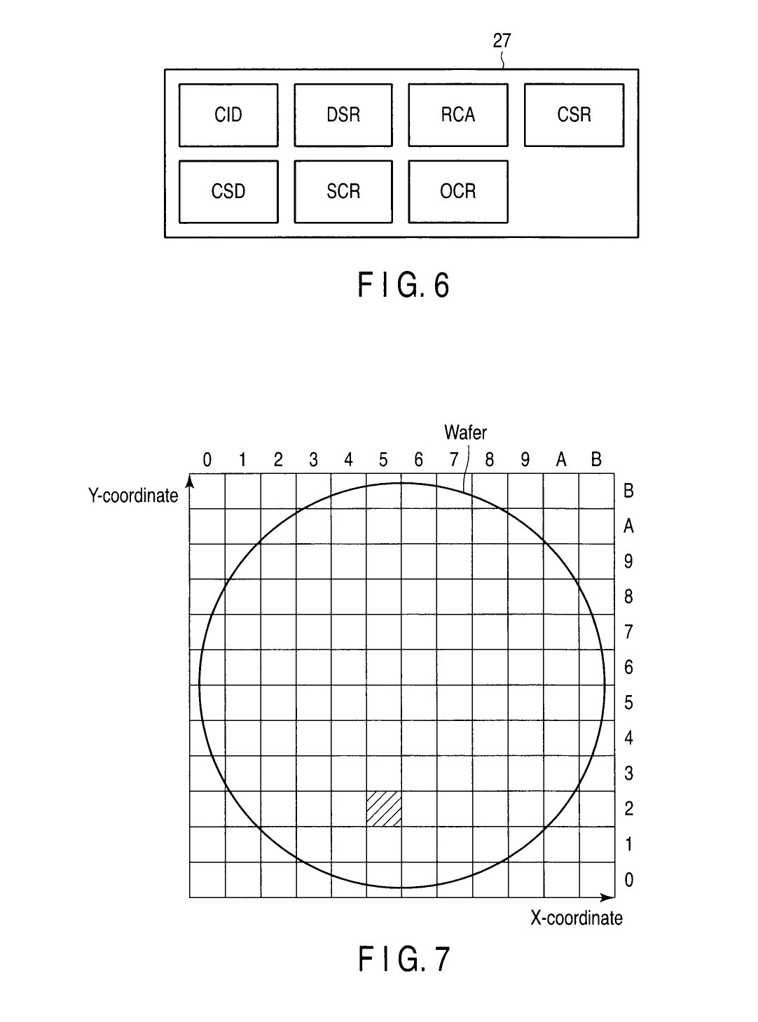

The register 27 includes various registers such as a card status register (CSR), a card identification number (CID), a relative card address (RCA), a driver stage register (DSR), card specific data (CSD), an SD configuration data register (SCR) and an operation condition register (OCR). A specific configuration of the register 27 will be described with reference to FIG. 6.

As illustrated in FIG. 6, the CSR is used in the normal operation and error information is stored, for example. The CID, RCA, DSR, CSD, SCR and OCR are used mainly when initiating the memory card 2.

The CID stores an identification number of the memory card 2. The RCA stores a relative card address. The DSR stores bus driving force and the like of the memory card 2. The CSD stores a specific parameter value of the memory card 2. The SCR stores data placement of the memory card 2. The OCR stores an operating voltage when an operating range voltage of the memory card 2 is limited.

The fuse block 29 includes a plurality of fuse devices and is supposed to be able to hold data of a plurality of bits (for example, 8 bits). The fuse device of the fuse block 29 holds information inherent to the controller 20. In other words, the fuse device holds a value inherent to the SD memory card 2 equipped with the controller 20, that is, a value inherent to a memory card product.

More specifically, the value held by the fuse device of the fuse block 29 may be positional information, in a semiconductor wafer, of the semiconductor substrate on which the controller 20 is formed. Alternatively, this value may be a product code, a lot number or a wafer number of the memory card 2 or a combination thereof.

The positional information in the semiconductor wafer of the semiconductor substrate will be described with reference to FIG. 7. FIG. 7 is an external view of the semiconductor wafer in a manufacturing process of the controller 20. FIG. 7 illustrates an XY coordinate of the semiconductor wafer.

As illustrated in FIG. 7, the controller 20 is formed on the semiconductor substrate in a state of the semiconductor wafer, and thereafter cut out from the semiconductor wafer by a dicing step to be an individual chip. The above-described positional information is the information indicating on which position the cut chip was in the semiconductor wafer.

For example, as illustrated in FIG. 7, suppose that the chip on which a certain controller 20 is formed was in a shaded region in a state of the wafer. Then, the position of the chip in the semiconductor wafer is represented as X=“5”, Y=“1”. Therefore, information X=“00000101”, Y=“00000001” is written to the fuse device in the fuse block 29 (binary display).

It goes without saying that not only the XY coordinate but also the above-described product code, lot number and wafer number may be written, or new information generated based on the information may be written. The information inherent to the controller 20 is hereinafter sometimes referred to as chip identification information.

Next, the encoder 28 will be described. The encoder 28 scrambles the write data at the time of writing data. The data scrambled by the encoder 28 is written to the NAND flash memory 10.

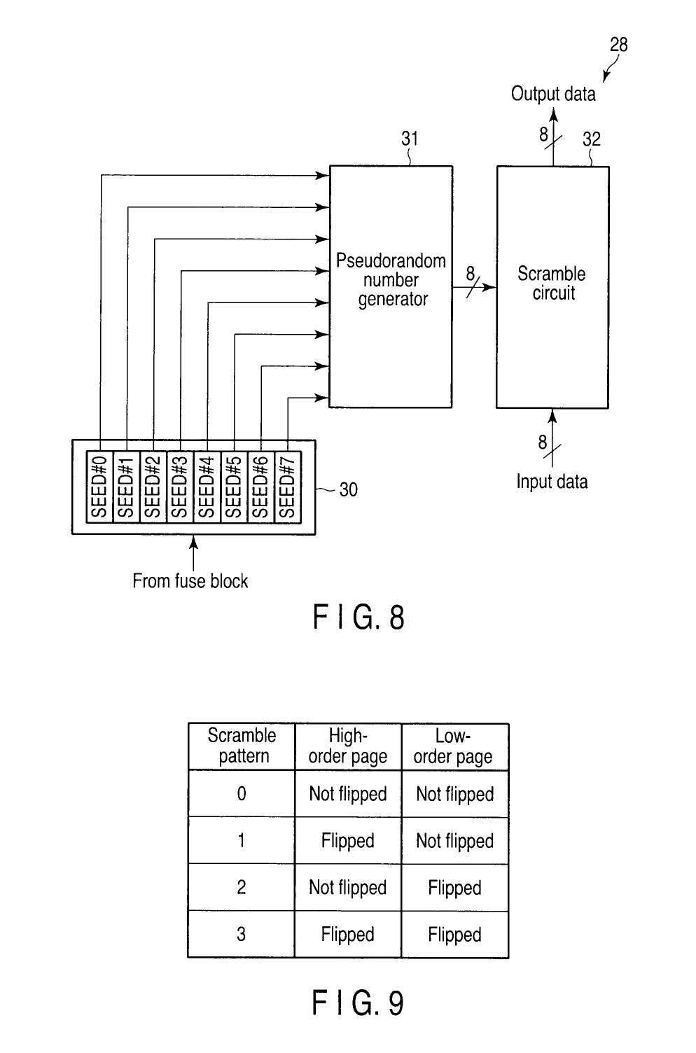

FIG. 8 is a block diagram of the encoder 28. As illustrated in FIG. 8, the encoder 28 includes a register 30, a pseudorandom number generator 31 and a scramble circuit 32.

The register 30 holds the information read from the fuse block 29. The information is, for example, 8 bits.

The pseudorandom number generator 31 generates the pseudorandom number using a value held by the register 30 as a seed value. Although a configuration of the pseudorandom number generator 31 is not specifically limited, a linear feedback shift register may be used, for example. The pseudorandom number generator 31 generates the pseudorandom number according to the instruction of the MPU 22, for example. Meanwhile, when the seed value is “00000000”, for example, there is a case in which the pseudorandom number generator 31 may not generate the pseudorandom number. In this case, the pseudorandom number generator 31 may convert the input seed value to “11111111”, for example, and thereafter generate the pseudorandom number using the converted value as the seed value.

The scramble circuit 32 scrambles the write data read from the RAM 24 based on the pseudorandom number generated by the pseudorandom number generator 31 at the time of writing data. More specifically, the scramble circuit 32 performs an exclusive OR (XOR) operation on the 8-bit write data and the 8-bit pseudorandom number, for example. Then, the scramble circuit 32 stores the result of the operation in the RAM 24 as the scramble data.

As illustrated in FIG. 9, the data is scrambled by the scramble circuit 32 (the scrambled data is referred to as scramble data). FIG. 9 is a table illustrating a scramble pattern of the write data, which may be taken by the pseudorandom number.

As illustrated, when a pattern 0 is selected, a high-order bit and a low-order bit of the write data are not flipped. That is, the scramble data is identical to the write data input to the scramble circuit 32. When a pattern 1 is selected, only the high-order bit is flipped. That is, when the write data is “00”, the scramble data becomes “10”. When a pattern 2 is selected, only the low-order bit is flipped. That is, when the write data is “00”, the scramble data becomes “01”. When a pattern 3 is selected, both of the high-order bit and the low-order bit are flipped. That is, when the write data is “00”, the scramble data becomes “11”. The pattern to be selected is determined by the pseudorandom number generated by the pseudorandom number generator 31, that is, the seed value held by the register 30.

### Writing Data

Next, operation of the controller 20 when writing the write data transferred from the host device 1 to the NAND flash memory 10 will be described.

First, the write command, the write data and the address from the host device 1 are received by the SD interface 21. The SD interface 21 supplies the write command to the MPU 22 and stores the write data and the address in the RAM 24.

The MPU 22, which has received the write command, reads the write data from the RAM 24 to supply the data to the encoder 28 and instructs the encoder 28 to generate the pseudorandom number and scramble the write data. Then, the encoder 28 generates the pseudorandom number based on the seed value held by the register 30. Also, the scramble circuit 32 scrambles the write data using the pseudorandom number generated by the pseudorandom number generator 31. Then, the scramble circuit 32 stores the scramble data in the RAM 24.

The MPU 22 continuously issues the write command to the NAND flash memory 10 and outputs the write command, the scramble data and the address in the RAM 24 to the NAND flash memory 10 through the NAND interface 25.

### Effect according to This Embodiment

If the seed value used in the pseudorandom number generator is the value common to each product and each firmware, when a third party may learn the seed value of a certain product by any method, the data of another product of the same model number might be decoded.

However, with the configuration according to this embodiment, the value inherent to each controller 20, for example, the positional information in the semiconductor wafer when manufacturing the controller chip and the like is used as the seed value. That is, the information, which the register for each controller 20 individually has, is used as the seed value, so that a scramble pattern differs from product to product even when the model number is the same. According to this, the pseudorandom number used at the time of data scramble differs even between the products of the same model number. Therefore, even when the seed value of a certain product is learned, it is possible to prevent the data from being decoded for another product of the same model number.

Since such encoding process by the data scramble also has an effect of distributing memory region to store the data, the process also has an aspect to reduce an effect of program disturb and the like by an effect from an adjacent memory cell occurring in association with minimization of the NAND flash memory and the like.

### Second Embodiment

Next, the controller and the data storage system according to a second embodiment will be described. This embodiment relates to the controller and the data storage system executing the encoding process to data when writing data to a hard disk (HDD) mounted in the personal computer and the like, for example. The pseudorandom number used in the encoding process is generated by using the value inherent to the controller as the seed as in the first embodiment.

### Entire Configuration of HDD Device 40

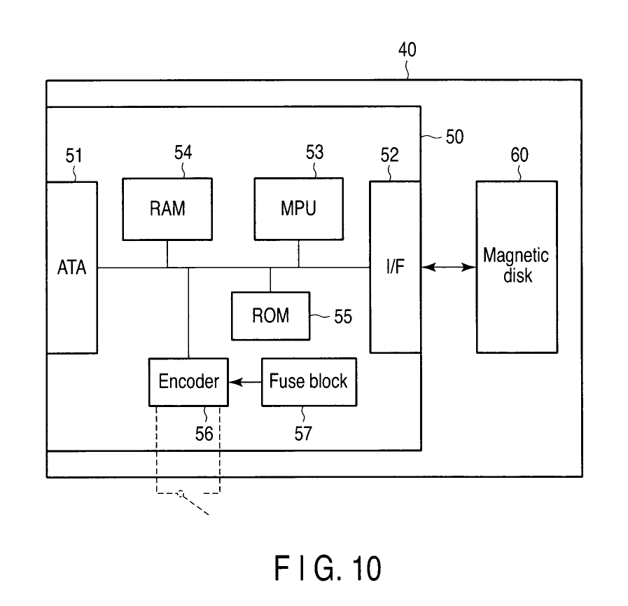

FIG. 10 is a block diagram of an HDD device 40 according to this embodiment. As illustrated, the HDD device 40 includes a controller 50 and a magnetic disk 60.

### Configuration of Magnetic Disk 60

The magnetic disk 60 records data. In the magnetic disk 60, a surface is a recording surface on which the data is magnetically recorded, for example. A magnetic head (not illustrated) is arranged so as to correspond to the recording surface of the magnetic disk 60. The magnetic head is used when writing data to the magnetic disk 60 and reading the data from the magnetic disk. Meanwhile, a rear surface of the magnetic disk 60 also serves as the recording surface, and a magnetic head similar to the above-described magnetic head may be arranged so as to correspond to the recording surface. Also, the hard disk 40 may have a configuration provided with a single magnetic disk 60, or a configuration in which a plurality of magnetic disks 60 are arranged in a stacking manner.

### Configuration of Controller 50

As illustrated in FIG. 10, the controller 50 includes interfaces 51 and 52, an MPU 53, a RAM 54, a ROM 55, an encoder 56 and a fuse block 57. They are integrally formed on the same substrate.

The interface 51 is an ATA (IDE) bus, for example, to perform the interface process with the host device (for example, the personal computer) not illustrated. The interface 51 receives the command and the write data, for example, from the host device. The interface 51 transfers the received command to the MPU 53 and stores the write data in the RAM 54, for example. Further, the interface 51 outputs the data, which should be output to the host device, according to an instruction of the MPU 53.

The interface 52 performs the interface process between the magnetic disk 60 and the controller 50. The interface 52 outputs the write data and the like to the magnetic disk 60 and receives the read data from the magnetic disk 60.

The MPU 53 controls operation of an entire HDD device 40. The MPU 53 receives the write command, the read command and the erase command transferred from the host device, and executes a predetermined process to the magnetic disk 60. Specifically, the MPU 53 performs control of a write voltage and modulation when reading and writing according to a track position of the magnetic disk, and control of input and output of the data. Also, when the HDD device 40 is supplied with the power, for example, the MPU 53 reads the firmware (control program) stored in the ROM 55 on the RAM 54 to execute a predetermined process. According to this, the various tables are created on the RAM 54.

Further, the MPU 53 controls the encoder 56 to encode the write data. The encoding process of the write data will be described later in detail.

The fuse block 57 is substantially similar to the fuse block 29 described in the first embodiment, so that the detailed description thereof is omitted. The fuse block 57 includes a plurality of fuse devices and is supposed to hold the data of a plurality of bits (for example, 8 bits). The fuse device of the fuse block 57 holds information inherent to the controller 50, a value inherent to a product of the HDD device in the second embodiment.

The ROM 55 stores the control program and the like controlled by the MPU 53. Also, the ROM 55 holds firmware information including a vender number and the like, for example.

The encoder 56 encodes the write data to the magnetic disk 60 given by the host device. Although a configuration of the encoder 56 is basically similar to that in the first embodiment, they differ from each other in that the scramble circuit in the configuration in FIG. 8 is replaced with an encoding circuit. The encoder 56 includes the register 30, the pseudorandom number generator 31 and the encoding circuit (hereinafter, referred to as an encoding circuit 32 for convenience). Since the register 30 and the pseudorandom number generator 31 are similar to those in the first embodiment, the detailed descriptions thereof are omitted. The encoding circuit 32 encodes the write data to the magnetic disk 60 by using the pseudorandom number generated by the pseudorandom number generator 31. Then, the encoded write data is stored in the RAM 54 and is thereafter written to the magnetic disk 60 by the MPU 53.

### Effect according to This Embodiment

With the configuration according to this embodiment, it is possible to encode the data and record the same in the HDD device in order to prevent information leakage. In this encoding, a value unique to the controller 50 (positional information of the controller chip and the like) is used as the seed value of the pseudorandom number generator in this embodiment. Therefore, as in the first embodiment, decoding of the encoded data may be effectively prevented.

Also, a case in which the encoders 28 and 56 scramble and encode the data has been described as an example in the first and second embodiments. However, the processes may be performed by the MPU 22 and 53. Also, the processes may be performed not in the controllers 20 and 50 but in the host device 1. In this case, the host device 1 receives the chip identification information of the controllers 20 and 50 and scrambles or encodes the data based on this chip identification information. Also, the encoders 28 and 56 may be provided in the host device 1.

The HDD device described in the second embodiment may be a built-in type arranged in a casing of the host device 1 or an external type arranged outside the casing as represented by a line in FIGS. 3 and 10, for example.

Also, in the first and second embodiments, it may be configured that on/off of the scramble and the encoding process by the encoders 28 and 56 is set on a user side. For example, in the first embodiment, the memory card 2 may receive a scramble instruction together with the write instruction. When the scramble instruction is received, the MPU 22 instructs the pseudorandom number generator 31 to generate the pseudorandom number and instructs the scramble circuit 32 to scramble. On the other hand, when the scramble instruction is not received, the MPU 22 does not instruct the generation of the pseudorandom number or the scramble. Therefore, in the latter case, the data is written to the NAND flash memory 10 without being scrambled. This is similar in the encoding process in the second embodiment.

Then, on/off of the scramble and the encoding process may be instructed by a signal from the host device or may be instructed by a switch and the like arranged in the memory card 2 and the HDD device 40.

Also, in the first and second embodiments, the scramble circuit 32 may scramble the data other than the pseudorandom number and the write data. That is, it is possible to scramble the seed value with the write data without generating the pseudorandom number from the pseudorandom number generator 31, for example. In this case, when the seed value is “00000000”, for example, there is a case in which the scramble circuit 32 may not scramble the data based on the seed value. In this case, the scramble circuit 32 may convert the input seed value to “11111111”, for example, and then use the converted value as the seed value to scramble with the write data.

The case in which the chip identification information in the fuse block 57 is used as the seed value when generating the pseudorandom number has been described as an example in the above-described second embodiment. However, from the viewpoint of the encoding, it is preferable to use a more complicated value (for example, larger bit number) as the seed. For this reason, data obtained by combining the chip identification information read from the fuse block 57 and information such as the vender number stored in the ROM 55 may be used as the seed, for example. According to this, the encoding harder to be decoded may be realized. It goes without saying that this may also be applied to the first embodiment.

Further, it is not necessary to obtain the chip identification information used for the seed value from the fuse blocks 29 and 57 in the controller 20.

That is, in the first embodiment, it is possible to further mount the fuse block 29 on the NAND flash memory 10 and obtain the chip identification information stored in the fuse block 29 to scramble the data based on the chip identification information. That is, the chip identification information in this case is the value according to the position on a silicon substrate when the NAND flash memory 10 is manufactured. In this case, the controller 20 and the NAND flash memory 10 are formed on the different silicon chips, so that the values of the chip identification information of both are naturally different from each other.

Also, in the second embodiment, a serial number different in each magnetic disk 60 is written as the identification information to a system region of the magnetic disk 60 before shipment. It is also possible for the controller 50 to obtain the identification information stored in the magnetic disk 60 to encode the data. In this case also, the identification information of the magnetic disk 60 and the chip identification information stored in the fuse block 57 are different from each other.

According to this, it is possible to obtain the chip identification information stored in the fuse block 29 mounted on the controller 20 and that mounted on the NAND flash memory 10, and combine them to obtain a new seed value, in the first embodiment. Similarly, in the second embodiment also, it is possible to obtain the identification information stored in the fuse block 57 of the controller 50 and the identification information stored in the magnetic disk 60, and combine them to obtain a new seed value.

Meanwhile, although the XY coordinate in the semiconductor wafer, the product code, the lot number and the wafer number have been described as the specific examples of the chip identification information in the first and second embodiments, the information is not particularly limited as long as it is the information inherent to the controller. Also, in the first embodiment, the pattern of the scramble may be changed for each word line WL (page) of the memory cell array 11. For example, the seed value may be generated by adding page address information, which becomes a write target of the data, to the chip identification information. According to this, it is possible that the pattern 1 in FIG. 9 is selected when the data is written to a certain page, and the pattern 2 is selected when the data is written to another page, for example.

Although only the scramble and the encoding process at the time of writing data have been described in the first and second embodiments, at the time of the reading of the data, the data may be decoded by performing a process opposite to that at the time of writing. That is, in the first embodiment, the decoder not illustrated decodes the read data using the pseudorandom number (pseudorandom number used at the time of the scramble) generated by the pseudorandom number generator 31. This is similar in the second embodiment.

Also, it is possible to further encode the write data in the first embodiment. That is, when there is the write instruction of the data from the host device 1, the MPU 22 or the encoder 28 (or the encoding circuit not illustrated) executes the encoding process on the write data, for example. Thereafter, the scramble (randomization) may be executed as described above on the encoded write data. At this time, the write data may be encoded by the pseudorandom number generated based on the chip identification information held in the fuse block 29.

Also, the NAND flash memory 10 and the controller 20 may be formed by one chip in the first embodiment. In this case, the fuse block 29 may be mounted on a side of a storage medium (for example, the NAND flash memory 10 in this case). Then, the controller 20 may read the chip identification information from the fuse block 29 mounted on the storage medium side to add to the seed value of the scramble process based on the chip identification information, thereby processing the data.

Also, in the above-described embodiment, a method of scrambling the data (XOR operation and another operation method) and a method of encoding the data may be selected based on the chip identification information in the fuse blocks 29 and 57. By changing a method of processing the pseudorandom number and the data by the chip identification information, leakage of the information may be further prevented.

Although the SD memory card has been described as an example in the above-described first embodiment, there is no limitation. That is, the invention is applicable to an MMC card, a USB flash memory, a flash solid state disk (SSD) and the like as long as they can hold the data. Also, the storage device of the storage medium is not limited to the NAND flash memory, but may be another flash memory such as an NOR flash memory or another nonvolatile semiconductor memory such as a ferroelectric memory. Although the HDD device has been described as an example in the second embodiment, the storage device is not limited to the HDD device as long as this performs the encoding process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller controlling a storage device connected to a host device and storing data, the controller comprising:
a pseudorandom number generator which generates a pseudorandom number based on identification information of the controller; and
a scramble circuit which scrambles data received from the host device using the pseudorandom number.

2. The controller according to claim 1, wherein the identification information includes at least chip positional information.

3. The controller according to claim 1, further comprising:
a control circuit which controls the pseudorandom number generator and the scramble circuit, wherein
when receiving a scramble instruction from the host device, the control circuit causes the scramble circuit to scramble the data and writes a scrambled data to the storage device, and
when not receiving the scramble instruction, the control circuit writes the data to the storage device without causing the scramble circuit to scramble the data.

4. The controller according to claim 1, wherein the scramble circuit is capable of scrambling the data using a plurality of scramble methods, and
the control circuit selects a specific scramble method out of the plurality of scramble methods based on the identification information.

5. The controller according to claim 1, further comprising:
a control circuit which controls the pseudorandom number generator and the scramble circuit according to on/off of a switch included in the storage device, wherein
when the storage device is switched on, the control circuit instructs the scramble circuit to scramble the data and instructs the storage device to write the data scrambled, and
when the storage device is switched off, the control circuit instructs the storage device to write the data not encoded without instructing the scramble circuit to scramble the write data.

6. The controller according to claim 2, wherein the positional information includes serial numbers different from each other given for the each storage device in addition to the chip positional information.

7. The controller according to claim 2, wherein
the chip positional information is any one or a combination of placement information of a silicon wafer to form the controller, a product code, a lot number and a wafer number.

8. A controller capable of connecting to a host device, the controller comprising:
a pseudorandom number generator which generates a pseudorandom number based on identification information of a storage device, the storage device which is capable of holding data being controlled by the controller; and
a scramble circuit which scrambles data received from the host device using the pseudorandom number.

9. The controller according to claim 8, wherein
the identification information includes at least chip positional information of the storage device.

10. The controller according to claim 8, wherein
the positional information includes serial numbers different from each other given for the each storage device.

11. The controller according to claim 8, further comprising:
a control circuit which controls the pseudorandom number generator and the scramble circuit; wherein
when receiving a scramble instruction from the host device, the control circuit instructs the scramble circuit to scramble the data and instructs the storage device to write the data scrambled, and
when not receiving the scramble instruction, the control circuit instructs the storage device to write the data without instructing the scramble circuit to scramble the write data.

12. The controller according to claim 8, wherein
the scramble circuit is capable of scrambling the data using a plurality of scramble methods, and
the control circuit selects a specific scramble method out of the plurality of scramble methods based on the identification information.

13. The controller according to claim 8, further comprising:
a control circuit which controls the pseudorandom number generator and the scramble circuit according to on/off of a switch included in the storage device, wherein
when the storage device is switched on, the control circuit instructs the scramble circuit to scramble the data and instructs the storage device to write the data scrambled, and
when the storage device is switched off, the control circuit instructs the storage device to write the data not encoded without instructing the scramble circuit to scramble the write data.

14. The controller according to claim 9, wherein
the chip positional information is any one or a combination of placement information of a wafer required to form the storage device, a product code, a lot number and a wafer number.

15. A data storage system comprising:
a storage device which is capable of holding data; and
a controller which controls the storage device, wherein
the controller includes
a pseudorandom number generator which generates a pseudorandom number based on identification information of the controller, and
a scramble circuit which scrambles write data to the storage device using the pseudorandom number.

16. The system according to claim 15, wherein
the identification information includes at least chip positional information.

17. The system according to claim 15, wherein the controller further comprises
a control circuit which controls the pseudorandom number generator and the scramble circuit, wherein
when receiving a scramble instruction from the host device, the control circuit instructs the scramble circuit to scramble the data and instructs the storage device to write the data scrambled, and
when not receiving the scramble instruction, the control circuit instructs the storage device to write the data not encoded without instructing the scramble circuit to scramble the write data.

18. The system according to claim 15, wherein
the scramble circuit capable of scrambling data using a plurality of scramble methods, and
the control circuit selects a specific scramble method out of the plurality of scramble methods based on the identification information.

19. The system according to claim 15, wherein the controller further comprises
a control circuit which controls the pseudorandom number generator and the scramble circuit according to on/off of a switch included in the storage device, wherein
when the storage device is switched on, the control circuit instructs the scramble circuit to scramble the data and instructs the storage device to write the data scrambled, and
when the storage device is switched off, the control circuit instructs the storage device to write the data not encoded without instructing the scramble circuit to scramble the write data.

20. The system according to claim 16, wherein
the positional information includes serial numbers different from each other given for the each storage device in addition to the chip positional information.
